(19) United States
(12) Patent Application Publication
(10) Pub. No.: US 2013/0057230 A1
(43) Pub. Date: Mar. 7, 2013

(54) POWER FACTOR CORRECTION CONTROL DEVICE AND ZERO-CURRENT DETECTION METHOD FOR POWER FACTOR CORRECTION CONTROL DEVICE

(71) Applicants: Joon Hyung Lim, Gyeonggi-do (KR); Sang Hoon Hwang, Seoul (KR); Sang Hyun Min, Gyeonggi-do (KR); Tah Joon Park, Gyeonggi-do (KR)

(72) Inventors: Joon Hyung Lim, Gyeonggi-do (KR); Sang Hoon Hwang, Seoul (KR); Sang Hyun Min, Gyeonggi-do (KR); Tah Joon Park, Gyeonggi-do (KR)

(21) Appl. No.: 13/598,501

(22) Filed: Aug. 29, 2012

(30) Foreign Application Priority Data
Sep. 1, 2011 (KR) 10-2011-0088602

(51) Int. Cl. G05F 1/70

(52) U.S. Cl. 323/209

(57) ABSTRACT

The present invention discloses an impedance matching apparatus. The impedance matching apparatus includes: a multilayer printed circuit board; a signal line including a plurality of signal layers with the same pitch and formed by sequentially arranging the plurality of signal layers on the multilayer printed circuit board; and a ground plane including a plurality of ground layers, wherein the plurality of ground layers are arranged to get closer to a bottom surface of the multilayer printed circuit board from a region corresponding to one side of the signal line to a region corresponding to the other side of the signal line. The impedance matching apparatus can implement a line width without any problem of a process yield by determining specific impedance by a distance between the signal layer and the ground layer formed in corresponding positions, thereby improving the process yield.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0088602, entitled filed Sep. 01, 2011, which is hereby incorporated by reference in its entirety into this application.

### BACKGROUND OF THE INVENTION

1. Field of the Invention

The present invention relates to a power factor correction control device and a zero-current detection method for power factor correction control device, and more particularly, to a power factor correction control device and a zero-current detection method for power factor correction control device to detect a zero-current of an inductor.

2. Description of the Related Art

A power factor correction control device controls to allow an output voltage to be constant by receiving a feedback voltage corresponding to the output voltage and controlling the output voltage according to the feedback voltage.

A commonly known power factor correction control device includes a converter unit, an input voltage sensing unit, an output voltage sensing unit and a switch control unit.

The converter unit is consist of a rectifying unit including a Bridge diode for rectifying a commercial AC power, an inductor connected to output sides of the rectifying unit for inducing current to a secondary side of the inductor, a switching device for controlling the input current flowing into the inductor, a diode and a capacitor for rectifying an output voltage of the inductor and supplying the rectified output voltage to a load terminal.

The input voltage sensing unit is constructed with a structure to connect a first and a second resistors connected to each other in serial to output sides of the Bridge diode in parallel and is capable of supplying an input voltage detected through a node between the first and the second resistors to the switch control unit.

The output voltage sensing unit is consist of a structure to connect a third and a fourth resistors connected in serial to output sides of the converter unit in parallel and is capable of detecting a level downed output voltage through a node between the third and the fourth resistors and supplying it to the switch control unit.

The switch control unit is consist of an adding unit for supplying a signal obtained by adding a voltage error outputted from a comparing unit to an input voltage supplied from the input voltage sensing unit to the driving unit, the comparing unit to detect the voltage error by comparing the output voltage with a reference voltage, a zero current detecting unit for detecting the zero current of the inductor to supply it to the driving unit and the driving unit for generating a control signal to control the switching device.

The switch control unit stores energy to a preset maximum current of the inductor until a following off time by turning on the switching device by detecting the zero current.

And, if the switch control unit reaches a peak current critical point of the inductor, the inductor current becomes reduced by turning off the switching device, at this time, the energy stored in the inductor during the time of the on period is transmitted to the load.

Meanwhile, the power factor correction control device detects the zero current of the inductor through the resistor formed in the ground of the switching device in order for the operation, but it is difficult to detect the voltage normally by generating the loss due to the voltage drop.

Therefore, the power factor correction control device employs a method of detecting the zero current of the inductor through a transformer connected to the inductor in parallel in place of the resistor in order to solve the above-described problems, but the transformer causes an increase in production cost.

### SUMMARY OF THE INVENTION

The present invention has been invented in order to overcome the above-described problems and it is, therefore, an object of the present invention to provide a power factor correction control device and a zero-current detection method for power factor correction control device to increase the efficiency of the Boost converter and reduce the cost thereof.

In accordance with an embodiment of the present invention to achieve the object, there is provided a power factor correction control device including: a converter unit, provided with a rectifying unit to rectify a commercial alternative current power, an inductor connected to an output side of the rectifying unit to store energy by an input current, a switching device to control the input current flowing into the inductor, and a diode and a capacitor to rectify an output voltage of the inductor and supply the rectified output voltage to a load terminal, to output a direct current voltage; a first voltage sensing unit to sense the input voltage by being connected to the output side of the rectifying unit of the converter unit; a second voltage sensing unit to sense a level downed output voltage of the converter unit by being connected to an output side of the converter unit; and a switch control unit to convert each of the input and output voltage supplied from the first and the second voltage sensing units to a first and a second digital values, respectively, and to control the switching device of the converter unit by using a zero-current of the inductor calculated by the first and the second digital values.

In accordance with another embodiment of the present invention to achieve the object, there is provided a power factor correction control device including: a converter unit, provided with a rectifying unit to rectify a commercial alternative current power, an inductor connected to an output side of the rectifying unit to store energy by an input current, a switching device to control the input current flowing into the inductor, and a diode and a plurality of capacitors to rectify an output voltage of the inductor and supply the rectified output voltage to a load terminal, to output a direct current voltage; a first voltage sensing unit to sense a first voltage by being connected to an input side of the diode; a second voltage sensing unit to sense a level downed second voltage of the converter unit by being connected to an output side of the diode; and a switch control unit to convert each of the first and the second voltage supplied from the first and the second voltage sensing units to a first and a second digital values, respectively, and to control the switching device of the converter unit by using a zero-current of the inductor calculated by the first and the second digital values.

In accordance with still another embodiment of the present invention to achieve the object, there is provided a zero-current detection method for a power factor correction control device including: digitalizing each of an input and an output voltages of the power factor correction control device into a first and a second digital values, respectively; calculating an on-time of a switching device by using the digitalized first and the second digital values; determining whether the on-time reaches a critical point or not, and turning off the switching device when the on-time reaches the critical point based on the determined result; calculating an off-time of the switching device by using the first digital value, the second digital value and the on-time; calculating a dead time of a predetermined time if the off-time is calculated; and turning on the switching device again when the dead time of the predetermined time is completed.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram showing a power factor correction control device in accordance with a first embodiment of the present invention;

FIG. 2 is a flow chart showing a detection method for detecting a zero-current of an inductor in a switch control unit of the power factor correction control device in accordance with the first embodiment of the present invention;

FIG. 3 is a graph showing a zero-current time of the inductor in the switch control unit of the power factor correction control device in accordance with a second embodiment of the present invention;

FIG. 4 is a view showing a power factor correction control device in accordance with a second embodiment of the present invention; and

FIG. 5 is a graph showing a zero-current time and a dead time of the inductor in the switch control unit of the power factor correction control device in accordance with the second embodiment of the present invention.

### DETAILED DESCRIPTION OF THE PREFERABLE EMBODIMENTS

Hereinafter, embodiments of the present invention will be described with reference to the accompanying drawings. The following embodiments are provided as examples, not limiting the present invention.

In describing the present invention, descriptions of well-known components and processing techniques are omitted so as not to unnecessarily obscure the embodiments of the present invention. The following terms are defined in consideration of functions of the present invention and may be changed according to users or operator's intentions or customs. Thus, the terms shall be defined based on the contents described throughout the specification.

The technical spirit of the present invention should be defined by the attached claims, and the following embodiments are merely means for efficiently explaining the technical spirit of the present invention to those skilled in the art.

Hereinafter, a power factor correction control device in accordance with embodiments of the present invention will be described with reference to the accompanying drawings.

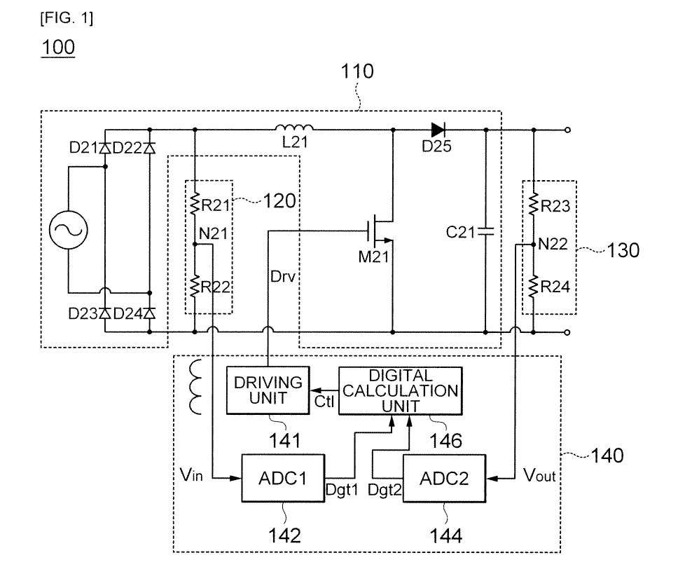

FIG. 1 is a diagram showing a power factor correction control device in accordance with a first embodiment of the present invention.

As shown in FIG. 1, a power factor correction control device 100 in accordance with a first embodiment of the present invention includes a converter unit 110, an input voltage sensing unit 120, an output voltage sensing unit 130 and a switch control unit 140.

The converter unit 110 is consist of a plurality of rectifying units D21, D22, D23, D24 including a Bridge diode for rectifying a commercial AC power, an inductor L21 connected to output sides of the rectifying units D21, D22, D23, D24 for inducing current to a secondary side of the inductor which is not shown by storing energy due to the input current, a switching device M21 for controlling the input current flowing into the inductor L21, a diode D25 and a capacitor C21 for rectifying an output voltage of the inductor L21 and supplying the rectified output voltage to a load terminal in order to output a DC voltage.

The input voltage sensing unit 120 is constructed with a structure to connect a first and a second resistors R21 and R22 connected to each other in serial to output sides of the rectifying units D21, D22, D23, D24 in parallel and is capable of supplying an input voltage Vin detected through a node N21 between the first and the second resistors R21 and R22 to the switch control unit 140.

The output voltage sensing unit 130 is consist of a structure to connect a third and a fourth resistors R23 and R24 connected in serial to output sides of the converter unit 110 in parallel and is capable of detecting a level downed output voltage V_{OUT} through a node N22 between the third and the fourth resistors R23 and R24 and supplying it to the switch control unit 140.

The switch control unit 140 digitalizes the input voltage Vin supplied from the input voltage sensing unit 120 and the output voltage V_{OUT} from the output voltage sensing unit 130, respectively, and is capable of controlling on/off of the switching device M21 by calculating a zero-current of the inductor L21 on the basis of the digitalized value thereof.

The switch control unit 140 may consist of a first analog-digital converter 142 (hereinafter referring to ADC), a second ADC 144, a digital calculation unit 146 and a driving unit 148.

The first ADC 142 is capable of digitalizing the input voltage Vin inputted from the input voltage sensing unit 120 into a first digital value Dgt1 to determine the on-time and supplying it to a digital calculation unit 146.

The second ADC 144 is capable of digitalizing the input voltage Vin inputted from the output voltage sensing unit 130 into a second digital value Dgt2 to determine the off time and supplying it to a digital calculation unit 146.

The digital calculation unit 146 generates a control signal cr1 to drive the switching device M21 based on the first and the second digital values Dgt1 and Dgt2 outputted from each of the first and the second ADC 142 and 144 and outputs it to the driving unit 148.

More particularly, the digital calculation unit 146 can calculate the on-time of the switching device by using the first digital value Dgt1 outputted from the first ADC 142. And, the switch control unit 140 is capable of storing up to a preset maximum current of the inductor L21 until the off-time by turning on the switching device M21 during the on-time period T1, A of FIG. 3, calculated in the digital calculation unit 146.

In addition, if an inductor current reaches a previously set reference peak current critical point, that is, if the on-time T1 is calculated and reaches the critical point, K of FIG. 3, the digital calculation unit 146 can the off-time T2, B of FIG. 3, by using the first digital value Dgt1 outputted from the first ADC 142 and the second digital value Dgt2 outputted from the second ADC 144. And the switch control unit 140 reduces the inductor current by turning off the switching device M21, at this time, and it transmits the energy stored in the inductor during the time of the previous on-time to a load.

On the other hands, the driving unit 148 can turn on/off the switching device M21 by generating the driving signal Dry of the switching device M21 based on the control signal Ct1 outputted from the digital calculation unit 146.

Like this, the power factor correction control device 100 in accordance with the present invention does not use a resistor or an auxiliary winding in order to sense the zero current of the inductor L21, but can detect the zero current of the inductor through the switch control unit 140 including the first ADC 142, the second ADC 144 and the digital calculation unit 146.

In this result, the power factor correction control device 100 in accordance with the present invention can increase the efficiency of the boost converter and reduce the production cost.

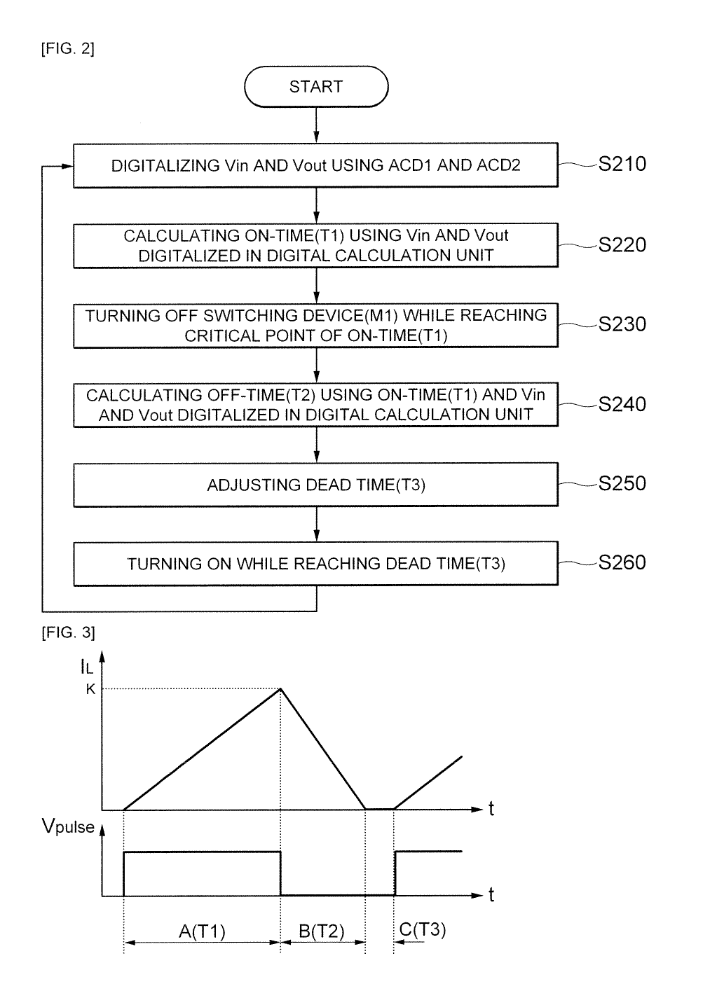

FIG. 2 is a flow chart showing a detection method for detecting a zero-current of an inductor in a switch control unit of the power factor correction control device in accordance with the first embodiment of the present invention.

At first, after the first and the second ADC 142 and 144 digitalize the input voltage Vin and the output voltage Vout inputted from the input voltage sensing unit 120 and the output voltage sensing unit 130, respectively, they can output the generated first and the second digital values Dgt1 and Dgt2 to the digital calculation unit 1146.

Then, the digital calculation unit 146 can calculate the on-time T1 of the switching device based on the first and the second inputted digital values Dgt1 and Dgt2 on the basis of the formula 1 and supply it to the driving unit 148 (S220). At this time, the on-time T1 means the A period of FIG. 3.

More specifically, the digital calculation unit 146 can calculate the on-time T1 of the switching device M21 using the first digital value Dgt1 among the inputted first and second digital values Dgt1 and Dgt2, the constant K and the inductor value L.

$$K = \frac{T 1 Vin}{L} \qquad Formula 1$$

At this time, the constant K of the formula 1 may represent a critical point of the on-time T1. The constant K can be set by performances and environments or the like of the system with an arbitrary set critical value, when the power factor correction control device is designed. And, the inductance value L can be determined by the inductor L21 applied to the power factor correction control device.

Thereafter, the digital calculation unit 146 can determine whether the on-time T1 reaches the critical point or not.

If the digital calculation unit 146 determines that the on-time T1 reaches the critical point based on the determined result, it can control the driving unit 148 on as to turn off the switching device M21 (S230).

And then, that is, after the switching device M21 is turned off, the digital calculation unit 146 can calculate the off time T2 of the switch device M21 (S240). At this time, the off time T2 means the B period of FIG. 3.

The off time T2 of the present invention can be determined based on the following formula 2 using the first and the second digital values Dgt1 and Dgt2 and the on-time T1.

$$T 2 = \frac{Vin}{Vout - Vin} T 1 \qquad Formula 2$$

And then, if the digital calculation unit 146 reaches the off time T2, the switching device M21 is not turned on directly, but the switching device M21 can be turned on by generating the control signal Cr1 after a predetermined time is passed by setting the dead time T3 for a soft switching of the switching device M21 (S250 and S260).

At this time, the dead time T3 means the C period of FIG. 3, and it can be changed by the performances and environments or the like of the system with an arbitrary set value.

Like this, the power factor correction control device 100 in accordance with the present invention does not use a resistor or an auxiliary winding for sensing the zero current of the inductor L21, but it can sense the zero current of the inductor through the switch control unit 140 including the first ADC 142, the second ADC 144 and the digital calculation unit 146.

In this result, the power factor correction control device 100 in accordance with the present invention can increase the efficiency of the boost converter and reduce the production cost.

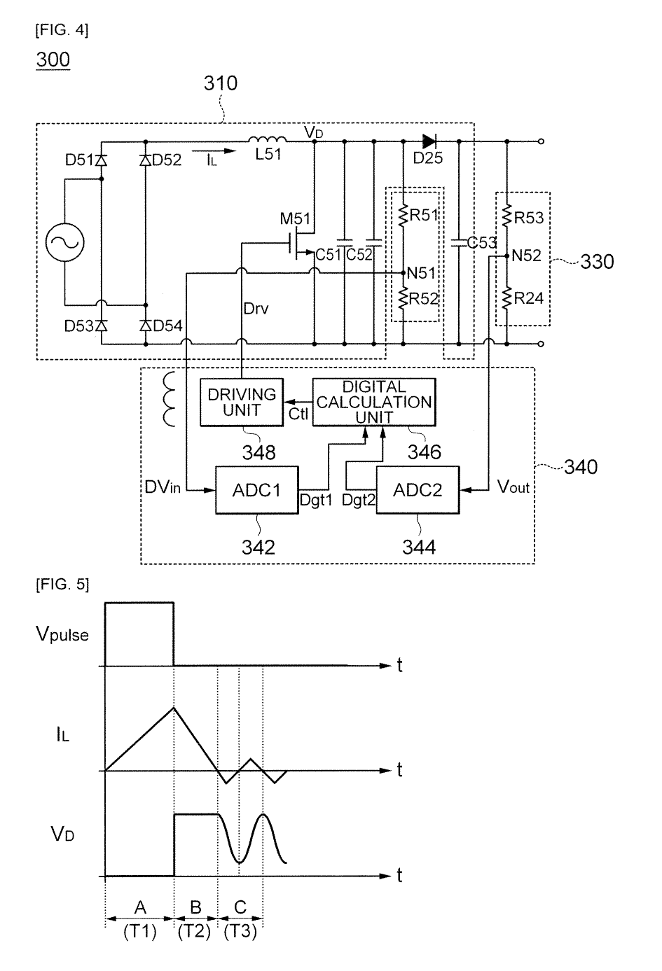

FIG. 4 is a view showing a power factor correction control device in accordance with a second embodiment of the present invention.

As shown in FIG. 4, the power factor correction control device 300 in accordance with the present invention includes a converter unit 310, a first voltage sensing unit 320, a second voltage sensing unit 330 and a switch control unit 340.

The converter unit 110 is consist of a plurality of rectifying units D51, D52, D53, D54 including a Bridge diode for rectifying a commercial AC power, an inductor L51 connected to output sides of the rectifying units D51, D52, D53, D54 for inducing current to a secondary side of the inductor which is not shown by storing energy due to the input current, a switching device M51 for controlling the input current flowing into the inductor L51, a diode D55 and a plurality of capacitors C51, C52 and C53 for rectifying an output voltage of the inductor L51 and supplying the rectified output voltage to a load terminal in order to output a DC voltage.

The first voltage sensing unit 320 is constructed with a structure to connect a first and a second resistors R51 and R52 connected to each other in serial to input sides of the diode D55 in parallel and is capable of supplying a first voltage DVin detected through a node N51 between the first and the second resistors R51 and R52 to the switch control unit 140.

The second voltage sensing unit 330 is consist of a structure to connect a third and a fourth resistors R53 and R54 connected in serial to output sides of the diode D55 in parallel and is capable of detecting a level downed second voltage V_{OUT} through a node N52 between the third and the fourth resistors R53 and R54 and supplying it to the switch control unit 140.

The switch control unit 340 generates and outputs a driving signal Dry to drive the switching device M51 by calculating a zero-current of the inductor L51 based on the first voltage DVin supplied from the first voltage sensing unit 320 and the second voltage Vout supplied from the second voltage sensing unit 330.

The switch control unit 340 may consist of a first analog-digital converter 342 (hereinafter referring to ADC), a second ADC 344, a digital calculation unit 346 and a driving unit 348.

The first ADC 342 generates a first digital value Dgt1 to determine the on-time. A period of FIG. 6, of the switching device M21 by receiving the first voltage DVin from the first voltage sensing unit 320 and supplies it to the digital calculation unit 346.

The second ADC 344 generates a second digital value Dgt2 to determine the off-time, B period of FIG. 6, of the switching device M21 by receiving the second voltage Vout from the second voltage sensing unit 330 and supplies it to the digital calculation unit 346.

The digital calculation unit 346 generates a control signal cr1 to drive the switching device M21 based on the first and the second digital values Dgt1 and Dgt2 outputted from each of the first and the second ADC 342 and 344 and outputs it to the driving unit 348.

More particularly, the digital calculation unit 346 can calculate the on-time of the switching device by using the first digital value Dgt1 outputted from the first ADC 342. And, the switch control unit 340 is capable of storing up to a preset maximum current of the inductor L51 until the off-time by turning on the switching device M51 during the on-time period T1, A of FIG. 5, calculated in the digital calculation unit 346.

In addition, if an inductor current reaches a previously set reference peak current critical point, that is, if the on-time T1 is calculated and reaches the critical point, the digital calculation unit 346 can the off-time T2. B of FIG. 5, by using the first digital value Dgt1 outputted from the first ADC 342 and the second digital value Dgt2 outputted from the second ADC 344. And the switch control unit 340 reduces the inductor current by turning off the switching device M51, at this time, and it transmits the energy stored in the inductor during the time of the previous on-time to a load.

In addition, the digital calculation unit 346 can control the driving unit 148 so as to implement a soft switching by completely discharging the current of the switching device M21 by determining the dead time T3, C period of FIG. 5, of the predetermined time.

At this time, the dead time T3 can be determined by the following formula 3.

Tosc=2π\sqrt{L*C51} (3)

Like this, the dead time T3 can be determined by the inductor L51 and the first capacitor C51.

But, the dead time T3 can be determined by the following formula 4 with adding one capacitor C52 thereto because it is difficult to forecast the component of the first capacitor C51.

Tosc/2=π{square root over (L*(C51+C52)} (4)

Like this, the dead time T3 of the present invention can be controlled by setting the oscillation frequency to a predict range similar to the C period of FIG. 6 by using one more capacitor in comparison with the formula 3.

The driving unit 348 can turn on/off the switching device M51 by generating the driving signal Drv of the switching device M51 based on the control signal Ct1 outputted from the digital calculation unit 346.

Like this, the power factor correction control unit 300 in accordance with the present invention does not use a resistor or an auxiliary winding for sensing the zero current of the inductor L51, but can detect the zero current of the inductor L51 through the control unit 340 including the first ADC 342, the second ADC 344 and the digital calculation unit 346.

In this result, the power factor correction control device 300 in accordance with the present invention can increase the efficiency of the Boost converter and reduce the production cost.

In addition, the power factor correction control device 300 in accordance with the present invention does not turn on the switching device M51 directly after the off-time is finished, but allow the switching device M51 to perform a soft switching by giving a predetermined time of dead time, thereby improving the power efficiency and securing the reliability by reducing the stress generated during the switch operation of the switching device.

The preferred embodiments of the present invention relate to a power factor correction control device and a zero-current detection method for power factor correction control device, and they are capable of detecting a zero-current of an inductor through the switch control unit including the first ADC, the second ADC and the digital calculation unit without using a resistor or an auxiliary winding for sensing the zero current of the inductor.

In this result, the power factor correction control device and the zero-current detection method for power factor correction control device can increase the efficiency of the Boost converter as well as reduce the production cost.

In addition, the power factor correction control device and the zero-current detection method for power factor correction control device do not directly turn on the switching device after the off-time is finished, but allow the switching device to perform a soft switching by giving a predetermined time of dead time, thereby improving the power efficiency and securing the reliability by reducing the stress generated during the switch operation of the switching device.

What is claimed is:

1. A power factor correction control device comprising:
a converter unit, provided with a rectifying unit to rectify a commercial alternative current power, an inductor connected to an output side of the rectifying unit to store energy by an input current, a switching device to control the input current flowing into the inductor, and a diode and a capacitor to rectify an output voltage of the inductor and supply the rectified output voltage to a load terminal, to output a direct current voltage;
a first voltage sensing unit to sense the input voltage by being connected to the output side of the rectifying unit of the converter unit;
a second voltage sensing unit to sense a level downed output voltage of he converter unit by being connected to an output side of the converter unit; and
a switch control unit to convert each of the input and output voltage supplied from the first and the second voltage sensing units to a first and a second digital values, respectively, and to control the switching device of the converter unit by using a zero-current of the inductor calculated by the first and the second digital values.

2. The power factor correction control device according to claim 1, wherein the switch control unit includes:
a first ADC (Analog-Digital Converter) to digitalize the input voltage inputted from the first voltage sensing unit into a first digitalized value;
a second ADC to digitalize the second voltage inputted from the output voltage sensing unit into a first digitalized value;
a digital calculation unit a control signal based on the first and the second digital values outputted from the first and the second ADCs, respectively; and
a driving unit to drive the switching device by using the control signal outputted from the digital calculation unit.

3. The power factor correction control device according to claim 1, wherein the digital calculation unit calculates an on-time of the switching device by a following formula 1 using the first digital value,
$$K = \frac{T 1 Vin}{L} \qquad Formula 1$$
at this time, the K is an arbitrary constant, the T1 is the on-time, the Vin is an input voltage value and the Lisa value of the inductor.

4. The power factor correction control device according to claim 3, wherein the switch control unit stores up to a predetermined maximum current of the inductor by turning on the switching device during the on-time period calculated at the digital calculation unit.

5. The power factor correction control device according to claim 3, wherein the digital calculation unit calculates an off-time based on a following formula 2 using the first and the second digital values, when the on-time is calculated,
$$T 2 = \frac{Vin}{Vout - Vin} T 1 \qquad Formula 2$$
at this time, the T1 is the on-time, the T2 is the off-time, the Vin is an input voltage value and the Vout is an output voltage value.

6. The power factor correction control device according to claim 5, wherein the switch control unit determines whether the on-time reaches a critical point or not, if the on-time reaches the critical point based on the determined result, and transmits the energy stored in the inductor during the on-time to a load by reducing an inductor current after the switching device turns off.

7. A power factor correction control device comprising:
a converter unit, provided with a rectifying unit to rectify a commercial alternative current power, an inductor connected to an output side of the rectifying unit to store energy by an input current, a switching device to control the input current flowing into the inductor, and a diode and a plurality of capacitors to rectify an output voltage of the inductor and supply the rectified output voltage to a load terminal, to output a direct current voltage;
a first voltage sensing unit to sense a first voltage by being connected to an input side of the diode;
a second voltage sensing unit to sense a level downed second voltage of the converter unit by being connected to an output side of the diode; and
a switch control unit to convert each of the first and the second voltage supplied from the first and the second voltage sensing units to a first and a second digital values, respectively, and to control the switching device of the converter unit by using a zero-current of the inductor calculated by the first and the second digital values.

8. The power factor correction control device according to claim 7, wherein the switch control unit includes:
a first ADC (Analog-Digital Converter) to digitalize the first voltage inputted from the first voltage sensing unit into a first digitalized value;
a second ADC to digitalize the second voltage inputted from the second voltage sensing unit into a first digitalized value;
a digital calculation unit a control signal based on the first and the second digital values outputted from the first and the second ADCs, respectively; and
a driving unit to drive the switching device by using the control signal outputted from the digital calculation unit.

9. The power factor correction control device according to claim 8, wherein the digital calculation unit calculates an on-time of the switching device by a following formula 1 using the first digital value,
$$K = \frac{T 1 Vin}{L} \qquad Formula 1$$
at this time, the K is an arbitrary constant, the T1 is the on-time, the Vin is an input voltage value and the L is a value of the inductor.

10. The power factor correction control device according to claim 8, wherein the switch control unit stores up to a predetermined maximum current of the inductor by turning on the switching device during the on-time period calculated at the digital calculation unit.

11. The power factor correction control device according to claim 9, wherein the digital calculation unit calculates an off-time based on a following formula 2 using the first and the second digital values, when the on-time is calculated,
$$T 2 = \frac{Vin}{Vout - Vin} T 1 \qquad Formula 2$$
at this time, the T1 is the on-time, the T2 is the off-time, the Vin is an input voltage value and the Vout is an output voltage value.

12. The power factor correction control device according to claim 11, wherein the switch control unit determines whether the on-time reaches a critical point or not, if the on-time reaches the critical point based on the determined result, and transmits the energy stored in the inductor during the on-time to a load by reducing a current of the inductor after the switching device turns off.

13. The power factor correction control device according to claim 9, wherein the digital calculation unit implements a soft switching by discharging a current of the switching device by determining a dead time of a predetermined time.

14. The power factor correction control device according to claim 13, wherein the dead time T_{OSC} of the predetermined time is determined by a following formula 3 using a value of the inductor and anyone capacitor among the plurality of capacitors,
Tosc=2π\sqrt{L*C51} (3)
at this time, the L is a value of the inductor and the C51 is a value of anyone capacitor.

15. The power factor correction control device according to claim 13, wherein the dead time T_{OSC} of the predetermined time is determined by a following formula 4 using a value of the inductor and two capacitors among the plurality of capacitors,
Tosc/2=π{square root over (L*(C51+C52)} (4)
at this time, the L is a value of the inductor and the C51 and the C52 are values of two capacitors.

16. A zero-current detection method for a power factor correction control device comprising:
digitalizing each of an input and an output voltages of the power factor correction control device into a first and a second digital values, respectively;
calculating an on-time of a switching device by using the digitalized first and the second digital values;
determining whether the on-time reaches a critical point or not, and turning off the switching device when the on-time reaches the critical point based on the determined result;
calculating an off-time of the switching device by using the first digital value, the second digital value and the on-time;
calculating a dead time of a predetermined time if the off-time is calculated; and
turning on the switching device again when the dead time of the predetermined time is completed.

17. The zero-current detection method for a power factor correction control device according to claim 16, wherein the digital calculation unit calculates an on-time of the switching device by a following formula 1 using the first digital value,
$$K = \frac{T 1 Vin}{L} \qquad Formula 1$$
at this time, the K is an arbitrary constant, the T1 is the on-time, the Vin is an input voltage value and the L is a value of the inductor.

18. The zero-current detection method for a power factor correction control device according to claim 16, wherein the digital calculation unit calculates an off-time based on a following formula 2 using the first and the second digital values, when the on-time is calculated,
$$T 2 = \frac{Vin}{Vout - Vin} T 1 \qquad Formula 2$$
at this time, the T1 is the on-time, the T2 is the off-time, the Vin is an input voltage value and the Vout is an output voltage value.

19. The zero-current detection method for a power factor correction control device according to claim 16, wherein the dead time T_{OSC} of the predetermined time is determined by a following formula 3 using a value of the inductor and anyone capacitor among the plurality of capacitors,
Tosc=2π\sqrt{L*C51} (3)
at this time, the L is a value of the inductor and the C51 is a value of anyone capacitor.

20. The zero-current detection method for a power factor correction control device according to claim 9, wherein the dead time T_{OSC} of the predetermined time is determined by a following formula 4 using a value of the inductor and two capacitors among the plurality of capacitors,
Tosc/2=π{square root over (L*(C51+C52)} (4)
at this time, the L is a value of the inductor and the C51 and the C52 are values of two capacitors.
